(19) United States
(12) Patent Application Publication
(10) Pub. No.: US 2022/0391448 A1
(43) Pub. Date: Dec. 8, 2022

(54) PERFORMANCE OPTIMIZATION OF VECTOR-BASED SEARCH AND METHODS OF USING THE SAME

(71) Applicant: adVentures, Inc., Cle Elum, WA (US)

(72) Inventor: Garrison Prinslow, Reston, VA (US)

(21) Appl. No.: 17/833,863

(22) Filed: Jun. 6, 2022

Related U.S. Application Data
(60) Provisional application No. 63/197,491, filed on Jun. 6, 2021.

(51) Int. Cl. G06F 16/901; G06F 16/906; G06F 16/903

(52) U.S. Cl. CPC G06F 16/9024; G06F 16/906; G06F 16/90335

(57) ABSTRACT

Various embodiments of the present application employ database structures in order to allow for a route graph to be created between geographical vertices, and for edges or arcs to be created between each vertex of the route graph, with various properties that are useful for refining a user's search parameters. The database structures allow for affine plane transformation algorithms to reduce the computational complexity of determining a route for the user based on the aforementioned criteria. Additionally, the route graph, as stored in a route graph database, allows for reuse and caching of prior vertices and arcs/edges to accelerate further searches based on similar criteria within the parameters specified by the user.

### BACKGROUND

This section introduces aspects that may help facilitate a better understanding of the disclosure. Accordingly, these statements arc to be read in this light and are not to be understood as admissions about what is or is not prior art.

Conventional system architectures related to searching are limited due to high computational expense and operational speed for user-desired content, based on a route that a user intends to travel. Additionally, conventional system architectures are limited in terms of the parameters that the user may employ to refine their searching. Various embodiments of the present disclosure address such issues.

### SUMMARY

One aspect of the present application relates to a system architecture includes a first protocol, wherein the first protocol is configured to receive input variables. The input variables include at least one of a start point, an end point, a decision point, or a point of interest. The input variables are received from a user device.

The system architecture additionally includes a second protocol, wherein the second protocol is configured to categorize the input variables into a route graph. A set of vertices of the route graph include the input variables. Further, the system architecture includes a third protocol, Wherein the third protocol is configured to map an edge or an arc between each vertex of the route graph. Next, the system architecture includes a fourth protocol wherein the fourth protocol is configured to update properties associated with the edge or the arc as at least one of time, distance, or rate, thereby creating an updated route graph. Moreover, the system architecture includes a fifth protocol, wherein the fifth protocol is configured to execute an affine plane reduction calculation on the updated route graph, thereby joining vertices of the updated route graph by edges or arcs between each vertex of the updated route graph to create a vector-based search route. Furthermore, the system architecture includes a sixth protocol, wherein the sixth protocol is configured to return the vector-based search route to the user device for display, thereby conducting a vector-based search.

Another aspect of the present application relates to a non-transitory computer-readable medium encoded with a computer-readable program, when executed by a processor, will cause a computer to execute a method of performing a vector-based search, wherein the method includes receiving input variables. The input variables include at least one of a start point, an end point, a decision point. or a point of interest. The input variables are received from a user device.

The method additionally includes categorizing the input variables into a route graph, A set of vertices of the route graph include the input variables. Further, the method includes mapping an edge or an arc between each vertex of the route graph. Next, the method includes updating properties associated with the edge or the arc as at least one of time, distance, or rate, thereby creating an updated route graph. Moreover, the method includes executing an affine plane reduction calculation on the updated route graph, thereby joining vertices of the updated route graph by edges or arcs between each vertex of the updated route graph to create a vector-based search route. Furthermore. the method includes returning the vector-based search route to the user device for display, thereby conducting a vector-based search.

### BRIEF DESCRIPTION OF THE DRAWINGS

One or more embodiments are illustrated by way of example, and not by limitation, in he figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates one example of a computing or processing node 1500 for operating a method or a software architecture in accordance with the present application.

### DETAILED DESCRIPTION

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiments) detailed herein and/or variations thereof are combinable with one or more embodiment(s) herein and/or variations thereof.

Various embodiments of the present application employ database structures in order to allow for a route graph to be created between geographical vertices, and for edges or arcs to be created between each vertex of the route graph, with various properties that are useful for refining a user's search parameters. The database structures allow for affine plane transformation algorithms to reduce the computational complexity of determining a route for the user based on the aforementioned criteria. Additionally, route graph, as stored in a route graph database, allows for reuse and caching of prior vertices and arcs/edges to accelerate further searches based on similar criteria within the parameters specified by the user.

Example 1: A system architecture includes a first protocol, wherein the first protocol is configured to receive input variables. The input variables include at least one of a start point, an end point, a decision point, or a point of interest. The input variables are received from a user device.

The system architecture additionally includes a second protocol, wherein the second protocol is configured to categorize the input variables into a route graph. A set of vertices of the route graph include the input variables. Further, the system architecture includes a third protocol, wherein the third protocol is configured to map an edge or an arc between each vertex of the route graph. Next, the system architecture includes a fourth protocol, wherein the fourth protocol is configured to update properties associated with the edge or the arc as at least one of time, distance, or rate, thereby creating an updated route graph. Moreover, the system architecture includes a fifth protocol, wherein the fifth protocol is configured to execute an affine plane reduction calculation on the updated route graph, thereby joining vertices of the updated route graph by edges or arcs between each vertex of the updated route graph to create a vector-based search route. Furthermore. the system architecture includes a sixth protocol, wherein the sixth protocol is configured to return the vector-based search route to the user device for display, thereby conducting a vector-based search.

In one or more embodiments, the route graph further includes a weighted directed graph. In at least one embodiment, the weighted directed graph further includes a rooted directed graph. In at least one embodiment, the rooted directed graph further includes a flow network graph,

In one or more embodiments, the second protocol includes a first procedure, wherein the first procedure is configured to create a flow network graph as a data structure in memory. Next, the second protocol includes a second procedure, wherein the second procedure is configured to save the start point as a source of the flow network graph. Further, the second protocol includes a third procedure, wherein the third procedure is configured to save the end point as a sink of the flow network graph. Moreover, the second protocol includes a fourth procedure, wherein the fourth procedure is configured to save at least one of the decision point or the point of interest as a vertex of the flow network graph, In at least one embodiment, a route database includes the flow network graph. The route database is based on at least one graph theory database programming language.

In one more embodiments, the fourth protocol includes a fifth procedure, wherein the fifth procedure is configured to create a sparse abstraction based on the route graph to create a set of saved values. The sparse abstraction includes the updated route graph. Next, the fourth protocol includes a sixth procedure, wherein the sixth procedure is configured to update, based on the sparse abstraction, the set of saved values of the properties associated with the edge or the arc as at least one of time, distance, or rate to an estimate database.

In at least one embodiment, the estimate database is based on at least one graph theory database programming language. The graph theory database programming language includes NoSQL, ArangoDB, DGraph, Grakn Core, Janus Graph, Nebula Graph, Neo4j, OpenLink Virtuoso, Oracle RDF Graph, OrientDB, Sparksee, or TerminusDB.

In one or more embodiments, the fourth protocol further includes a seventh procedure, wherein the seventh procedure is configured to receive a user location through the user device. Next, the fourth protocol includes an eighth procedure, wherein the eighth procedure is configured to perform the updating of the properties associated with the edge or the arc as at least one of time, distance, or rate based upon a time-based parameter after the receiving of the user location.

In at least one embodiment, the time-based parameter includes a range of 1 to 150 seconds.

In one or more embodiments, the fourth protocol includes a ninth procedure, wherein the ninth procedure is configured to update in a batch operation during off-peak usage time.

In at least one embodiment, the graph theory database programming language includes NoSQL, ArangoDB, DGraph, Grakn Core, Janus Graph, Nebula Graph, Neo4j, OpenLink Virtuoso, Oracle RDF Graph, OrientDB, Sparksee, or TerminusDB. The route database supports a query layer that queries the data layer employing at least one graph-based database query language. In at least one embodiment, the graph-based database query language comprises AQL, Cypher Query Language, GQL, GraphQL, Gremlin, or SPARQL.

In one or more embodiments, the estimate database supports a query layer that queries the data layer employing at least one graph-based database query language. In at least one embodiment, the graph-based database query language includes AQL, Cypher Query Language, GQL, GraphQL, Gremlin, or SPARQL.

In one or more embodiments, the sixth procedure of the fourth protocol includes a first routine, wherein the first routine is configured to update the set of saved values of the time, distance, and rate based on a continuous moving average.

In one or more embodiments, the eighth procedure of the fourth protocol includes a second routine, wherein the second routine is configured to receive input data from the user device by querying location protocols of the user device based on the time-based parameter.

Example 2: A non-transitory computer-readable medium encoded with a computer-readable program, when executed by a processor, will cause a computer to execute a method of performing a vector-based search. wherein the method includes receiving input variables. The input variables include at least one of a start point, an end point, a decision point, or a point of interest. The input variables are received from a user device.

The method additionally includes categorizing the input variables into a route graph. A set of vertices of the route graph include the input variables. Further, the method includes mapping an edge or an arc between each vertex of the route graph. Next, the method includes updating properties associated with the edge or the arc as at least one of time, distance, or rate, thereby creating an updated route graph. Moreover, the method includes executing an affine plane reduction calculation on the updated route graph, thereby joining vertices of the updated route graph by edges or arcs between each vertex of the updated route graph to create a vector-based search route. Furthermore, the method includes returning the vector-based search route to the user device for display, thereby conducting a vector-based search.

In one or more embodiments, the route graph further includes a weighted directed graph. In at least one embodiment, the weighted directed graph further includes a rooted directed graph. in at least one embodiment, the rooted directed graph further includes a flow network graph.

In one or more embodiments, the categorizing the input variables into the route graph using the second protocol includes creating a flow network graph as a data structure in memory. Next, the method includes saving the start point as a source of the flow network graph. Further, the method includes saving the end point as a sink of the flow network graph. Moreover, the method includes saving at least one of the decision point or the point of interest as a vertex of the flow network graph. In at least one embodiment, a route database includes the flow network graph. The route database is based on at least one graph theory database programming language.

In one more embodiments, the updating the properties associated with the edge or the arc as at least one of time, distance, or rate includes creating a sparse abstraction based on the route graph to create a set of saved values. The sparse abstraction includes the updated route graph. Next, the method includes updating, based on the sparse abstraction, the set of saved values of the properties associated with the edge or the arc as at least one of time, distance, or rate to an estimate database.

In at least one embodiment, the estimate database is based on at least one graph theory database programming language. The graph theory database programming language includes NoSQL, ArangoDB, DGraph, Grakn Core, Janus Graph, Nebula Graph, Neo4j, OpenLink Virtuoso, Oracle RDF Graph, OrientDB, Sparksee, or TerminusDB.

In one or more embodiments, the updating the properties associated with the edge or the arc as at least one of time, distance, or rate further includes receiving a user location through the user device. Next, the method includes performing the updating of the properties associated with the edge or the arc as at least one of time, distance, or rate based upon a time-based parameter after the receiving of the user location.

In at least one embodiment, the time-based parameter includes a range of 1 to 150 seconds.

In one or more embodiments, the updating the properties associated with the edge or the arc as at least one of time, distance, or rate includes updating in a batch operation during off-peak usage time.

In at least one embodiment, the graph theory database programming language includes NoSQL, ArangoDB, DGraph, Grakn Core, Janus Graph, Nebula Graph, Neo4j, OpenLink Virtuoso, Oracle RDF Graph, OrientDB, Sparksee, or TerminusDB. The route database supports a query layer that queries the data layer employing at least one graph-based database query language. In at least one embodiment, the graph-based database query language comprises AQL, Cypher Query Language, GQL, GraphQL, Gremlin, or SPARQL.

In one or more embodiments, the estimate database supports a query layer that queries the data layer employing at least one graph-based database query language. In at least one embodiment, the graph-based database query language includes AQL, Cypher Query Language, GQL, GraphQL, Gremlin, or SPARQL.

In one or more embodiments, the updating the set of saved values of the properties associated with the edge or the arc as at least one of time, distance, or rate to an estimate database includes updating the set of saved values of the time, distance, and rate based on a continuous moving average.

In one or more embodiments, the performing the updating of the properties associated with the edge or the arc as at least one of time, distance, or rate based upon the time-based parameter after the receiving of the user location includes receiving input data from the user device by querying location protocols of the user device based on the time-based parameter.

One of ordinary skill in the art would recognize that operations are added or removed from the above method, in one or more embodiments. One of ordinary skill in the art would also recognize that the order of the operations in the above method is varied in various alternative embodiments.

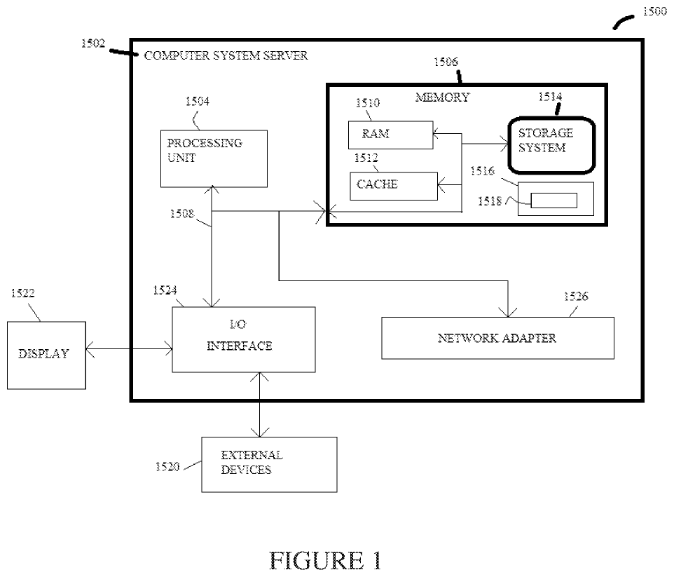

FIG. 1 illustrates one example of a computing or processing node 1500 for operating the methods and the software architecture of the present application. This is not intended to suggest any limitation as to the scope of use or functionality of embodiments of the invention described. herein. Regardless, the computing node 1500 is capable of being implemented and/or performing any of the functionality set forth hereinabove.

In computing node 1500 there is a computer system/server 1502, which is operational with numerous other general purpose or special purpose computing system environments or configurations. Examples of well-known computing systems, environments, and/or configurations that array be suitable for use with computer system/server 1502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 1502 in cloud computing node 1500 is shown in the form of a general-purpose computing device. The components of computer system/server 1502 may include, but are not limited to, one or more processors or processing units 1504, a system memory 1506, and a bus 1508 that couples various system components including system memory 1506 to processor 1504.

Bus 1508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1502 typically includes a variety of computer system readable media. Such media may be any available media that is accessible by computer system/server 1502, and it includes both volatile and non-volatile media, removable and non-removable media.

System memory 1506, in one embodiment, implements the methods and the software architectures of the present application. The system memory 506 can include computer system readable media in the form of volatile memory, such as random access memory (RAM) 1510 and/or cache memory 1512. Computer system/server 1502 may further include other removable/non-removable, volatile/non-volatile computer system storage media. By way of example only, storage system 1514 can be provided for reading from and writing to a non-removable non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1508 by one or more data media interfaces. As will be further depicted and described below, memory 1506 may include at least one program product having a set (e at least one) of program modules that are configured to carry out the functions of various embodiments of the invention.

Program/utility 1516, having a set (at least one) of program modules 1518, may be stored in memory 1506 by way of example, and not limitation, as well as an operating system, one or more application programs, other program modules, and program data. Each of the operating system, one or more application programs, other program modules, and program data or some combination thereof, may include an implementation of a networking environment. Program modules 1518 generally carry out the functions and/or methodologies of various embodiments of the invention as described herein.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer system/server 1502 may also communicate with one or more external devices 1520 such as a keyboard, a pointing device, a display 1522, etc.; one or more devices that enable a user to interact with computer system/server 1502; and/or any devices (e.g., network card, modem, etc.) that enable computer system/server 1502 to communicate with one or more other computing devices. Such communication can occur via I/O interfaces 1524. Still yet, computer system/server 1502 can communicate with one or more networks such as a local area network (LAN), a general wide area network (WAN), and/or a public network the Internet) via network adapter 1526. As depicted, network adapter 1526 communicates with the other components of computer system/server 1502 via bus 1508. It should be understood that although not shown, other hardware and/or software components could be used in conjunction with computer system/server 1502. Examples, include, but are not limited to: microcode, device drivers, redundant processing units, external disk drive arrays, RAID systems, tape drives, and data archival storage systems, etc.

Although the present disclosure and its advantages have been described in detail, it should be understood that various changes, substitutions and alterations can he made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include in their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intentions not to be limited to the details given herein. For example, the various elements or components may be combined or integrated in another system or certain features may be omitted, or not implemented.

1. A non-transitory computer-readable medium encoded with a computer-readable program, when executed by a processor, will cause a computer to execute a method of performing a vector-based search, wherein the method comprises:
receiving input variables, wherein the input variables comprise at least one of a start point, an end point, a decision point, or a point of interest, wherein the input variables are received from a user device;
categorizing the input variables into a route graph, wherein a set of vertices of the route graph comprises the input variables;
mapping an edge or an arc between each vertex of the route graph;
updating properties associated with the edge or the arc as at least one of time, distance, or rate, thereby creating an updated route graph;
executing an affine plane reduction calculation on the updated route graph, thereby joining vertices of the updated route graph by edges or arcs between each vertex of the updated route graph to create a vector-based search route; and
returning the vector-based search route to the user device for display, thereby conducting a vector-based search.

2. The method of claim wherein the route graph further comprises a weighted directed graph.

3. The method of claim 2, wherein the weighted directed graph further comprises a rooted directed graph.

4. The method of claim 3, wherein the rooted directed graph further comprises a flow network graph.

5. The method of claim 1, wherein the categorizing the input variables into the route graph comprises:
creating a flow network graph as a data structure in memory;
saving the start point as a source of the flow network graph;
saving the end point as a sink of the flow network graph; and
saving at least one of the decision point or the point of interest as a vertex of the flow network graph.

6. The method of claim 5, further comprising a route database, wherein the route database comprises the flow network graph, and wherein the route database is based on at least one graph theory database programming language.

7. The method of claim 1, wherein the updating the properties associated with the edge or the arc as at least one of time, distance, or rate comprises:
creating a sparse abstraction based on the route graph to create a set of saved values, wherein the sparse abstraction comprises the updated route graph; and
based on the sparse abstraction, updating the set of saved values of the properties associated with the edge or the arc as at least one of time, distance, or rate to an estimate database.

8. The method of claim 7, wherein the estimate database is based on at least one graph theory database programming language, wherein the graph theory database programming language comprises NoSQL, ArangoDB, DGraph, Grakn Core, Janus Graph, Nebula Graph, Neo4j, OpenLink Virtuoso, Oracle RDF Graph, OrientDB, Sparksee, or TerminusDB.

9. The method of claim 7, wherein the updating the properties associated with the edge or the arc as at least one of time, distance, or rate further comprises:
receiving a user location through the user device; and
performing the updating of the properties associated with the edge or the arc as at least one of time, distance, or rate based upon a time-based parameter after the receiving of the user location.

10. The method of claim 9, wherein the time-based parameter comprises a range of 1 to 150 seconds.

11. The method of claim 1, wherein the updating the properties associated with the edge or the arc as at least one of time, distance, or rate comprises:
updating in a batch operation during off-peak usage time.

12. The method of claim 6, wherein the graph theory database programming language comprises NoSQL, ArangoDB, DGraph, Grakn Core, Janus Graph, Nebula Graph, Neo4j, OpenLink Virtuoso, Oracle RDF Graph, OrientDB, Sparksee, or TerminusDB.

13. The method of claim 6, wherein the route database supports a query layer that queries the data layer employing at least one graph-based database query language.

14. The method of claim 13, wherein the graph-based database query language comprises AQL, Cypher Query Language, GQL, GraphQL, Gremlin, or SPARQL.

15. The method of claim 8, wherein the estimate database supports a query layer that queries the data layer employing at least one graph-based database query language.

16. The method of claim 15, wherein the graph-based database query language comprises AQL, Cypher Query Language, GQL, GraphQL, Gremlin, or SPARQL.

17. The method of claim 7, wherein the updating the set of saved values of the properties associated with the edge or the arc as at least one of time, distance, or rate to an estimate database comprises:
updating the set of saved values of the time, distance, and rate based on a continuous moving average.

18. The method of claim 9, wherein the performing the updating of the properties associated with the edge or the arc as at least one of time, distance, or rate based upon the time-based parameter after the receiving of the user location comprises:
receiving input data from the user device by querying location protocols of the user device based on the time-based parameter.
